(19) United States
(12) Patent Application Publication
(10) Pub. No.: US 2026/0116669 A1
(43) Pub. Date: Apr. 30, 2026

(54) Method of Self-Feeding Proppant Delivery to a Blender

(71) Applicant: Halliburton Energy Services, Inc., Houston, TX (US)

(72) Inventors: Cameron Michael Kramer, Duncan, OK (US); Chad A. Fisher, Cache, OK (US)

(73) Assignee: Halliburton Energy Services, Inc., Houston, TX (US)

(21) Appl. No.: 18/929,247

(22) Filed: Oct. 28, 2024

(51) Int. Cl. B65G 43/08; B65G 65/28; B65G 67/24; B65G 69/18

(52) U.S. Cl. CPC B65G 43/08; B65G 65/28; B65G 67/24; B65G 69/185; B65G 2811/095; B65G 2814/0344

(57) ABSTRACT

A method for transferring proppant that has been delivered to a worksite by a transport vehicle to a blender includes creating a pile of the proppant, using an unloader and/or a stacker, at a proppant inlet of a self-feeding conveyor and transferring the proppant, using the self-feeding conveyor without operator interaction and a metering conveyor, from the pile to the blender. The method further includes controlling a mass rate, using the metering conveyor, to vary at least one of a speed of the self-feeding conveyor, a speed of the metering conveyor, or a variable opening onto the self-feeding conveyor and/or the metering conveyor; and supplying the proppant, using the metering conveyor, to the blender at a selected rate.

### BACKGROUND

This section is intended to introduce the reader to various aspects of the art that may be related to various aspects of the presently described embodiments—to help facilitate a better understanding of various aspects of the present embodiments. Accordingly, it should be understood that these statements are to be read in this light, and not as admissions of prior art.

To produce hydrocarbons (for example, oil, gas, and the like) from a subterranean formation, wellbores may be drilled that penetrate hydrocarbon-containing portions of the subterranean formation. The portion of the subterranean formation from which hydrocarbons may be produced is commonly referred to as a “production zone.” In some instances, a subterranean formation penetrated by the wellbore may have multiple production zones at various locations along the wellbore.

Generally, after a wellbore has been drilled to a desired depth, completion operations are performed. Such completion operations may include inserting a liner or casing into the wellbore and, at times, cementing the casing or liner into place. Once the wellbore is completed as desired (lined, cased, open hole, or any other known completion), a stimulation operation may be performed to enhance hydrocarbon production into the wellbore. Examples of some common stimulation operations involve hydraulic fracturing, acidizing, fracture acidizing, and hydrajetting. Stimulation operations are intended to increase the flow of hydrocarbons from the subterranean formation surrounding the wellbore into the wellbore itself so that the hydrocarbons may then be produced up to the wellhead.

One typical formation stimulation process may involve hydraulic fracturing of the formation and placement of a proppant in the fractures created. Typically, a stimulation fluid (comprising at least a clean fluid and a proppant) is mixed at the surface before being pumped downhole in order to induce fractures or perforations in the formation of interest. The creation of such fractures or perforations will increase the production of hydrocarbons by increasing the flow paths into the wellbore. Injecting proppant into fractures can help ensure that fractures remain open for downhole fluids to flow through.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings.

FIG. 1 is an aerial view of a well stimulation worksite.

FIG. 2 is a perspective view of a self-feeding proppant delivery system in accordance with one or more embodiments of the present disclosure.

FIG. 3 is a schematic view of a self-feeding proppant delivery system in accordance with one or more embodiments of the present disclosure.

FIG. 4 is a perspective view of two self-feeding conveyors in accordance with one or more embodiments of the present disclosure.

FIGS. 5A-5C are perspective views of dust-suppressing systems in accordance with one or more embodiments of the present disclosure.

FIG. 6 is a flowchart of a method according to one or more embodiments of the present disclosure.

### DETAILED DESCRIPTION

The present disclosure relates to a self-feeding proppant system for delivering proppant to a blender and a method of controlling the same. One or more specific embodiments of the present disclosure will be described below. In an effort to provide a concise description of these embodiments, not all features of an actual implementation may be described. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

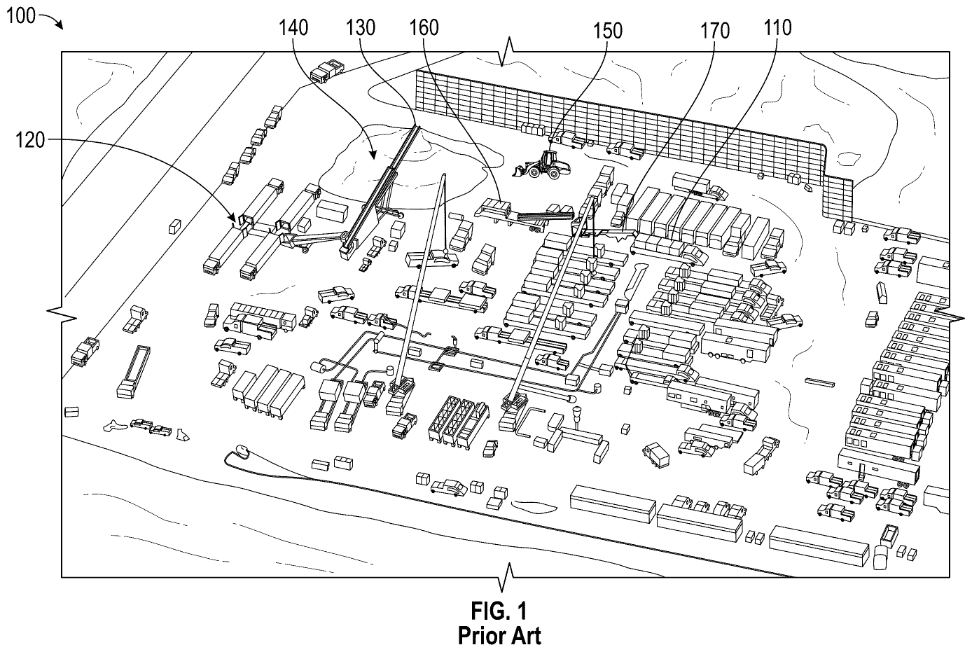

FIG. 1 presents an aerial view of a worksite 100 near a location where a well (not shown) is being drilled to produce hydrocarbons. The worksite 100 is arranged to supply proppant to a blender 110. The blender 110 mixes the proppant with a fluid. This mixture is then pumped under pressure into the well. The proppant may be a sand or man-made ceramic materials. The proppant may be delivered to the worksite using transport vehicles such as a belly dump (or bottom dump) trailer, a side dump truck, a back-opening dump truck, to name a few. The type of dump truck will be matched to the type of unloader (or truck unloader) 120 at the worksite. For belly dump trucks, an unloader 120 that receives the proppant from below the truck is used. The unloader 120 is a conveyor, for example a conveyor belt or an auger, though other means of conveyance of the proppant may be used. The unloader 120 moves the proppant to the hopper of the stacker 130. The hopper receives the proppant, which then may be lifted by the stacker 130 and dropped onto the pile 140 of proppant. The unloader 120 and the stacker 130 are both members of the intake system. In one or more embodiments, the unloader 120 and the stacker 130 may be a single apparatus that receives proppant from a transport vehicle and delivers the proppant to the pile.

Continuing to refer to FIG. 1, proppant in the pile 140 is scooped up by a wheel loader 150 and delivered to a feed hopper conveyor 160. The wheel loader 150 requires an operator. Because operations requiring injecting proppant into a well can run 24 hours per day over several days, using a wheel loader 150 to transfer proppant presents a number of costs and potential liabilities. First is the labor requirement of at least one operator at all times. Second, the wheel loader 150 running back and forth between the pile 140 of proppant and the feed hopper conveyor 160 increases the risk of injury to personnel and damage to equipment in the case of an accident or mishap.

After the proppant is placed on the feed hopper conveyor 160, the proppant is carried to a metering conveyor 170. The metering conveyor 170 measures and controls the mass (or weight) of proppant being delivered to the blender 110 per unit time. The mass of proppant delivered per unit time may be referred to as the mass rate. The metering conveyor includes a sensor operable to indicate the amount of material at the inlet of the metering conveyor. As the metering conveyor requires more or less proppant, the mass rate may be adjusted in various ways. The speed of the transfer conveyor (and the self-feeding conveyor) can be adjusted to match the demand. In one or more embodiments, the metering conveyor may include a controller that is configured to control the speed of the transfer conveyor and/or the speed of the self-feeding conveyor. In one or more embodiments, the mass rate may be controlled with a variable opening that varies the rate at which proppant is delivered onto the transfer conveyor or onto the metering conveyor. One or more conveyors may operate at a fixed speed. The mass rate at which proppant is delivered may be controlled by a combination of a variable opening and a variable speed of one or more conveyor belts. The amount of proppant needed per unit time (that is, a proppant delivery rate) may vary throughout the process. The rate may be selected by a user before the beginning of operations and may be adjusted by a user as needed during operations. In another embodiment, the rate may be determined by the evaluation of sensor data from one or more sensors at the surface or downhole. A controller may run an algorithm to determine the proppant delivery rate based on sensor data and/or user input. Thus, the metering conveyor 170 must respond to changing instructions from a user or external controller.

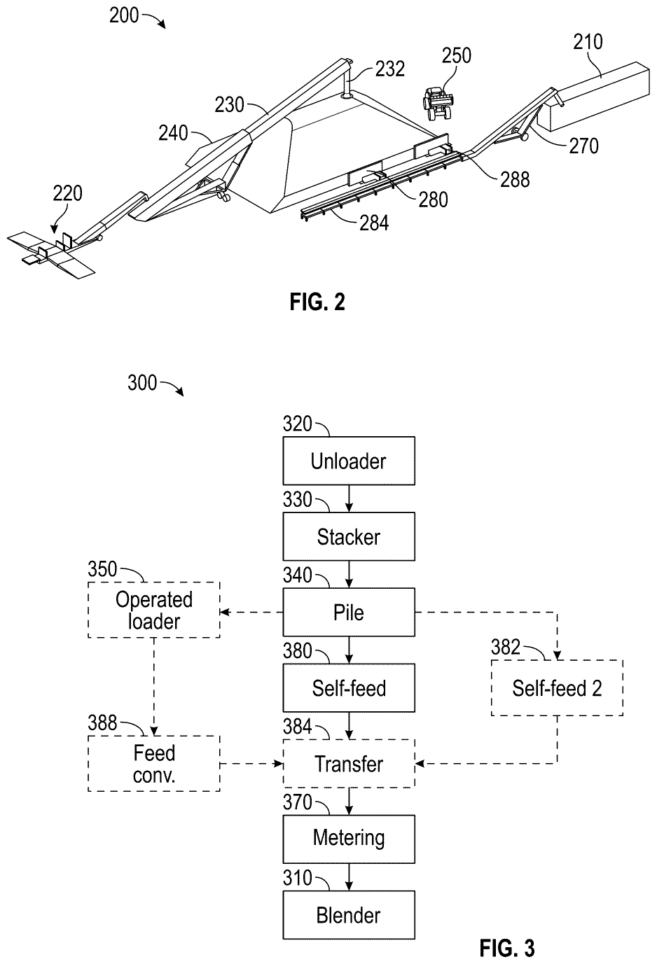

Referring now to FIG. 2, a self-feeding proppant delivery system 200 is presented in perspective view. Features similar to those discussed previously will not be repeated here. An unloader 220 is operable to receive proppant from a truck or other transport vehicle. As represented in FIG. 2, the truck may be a belly dump truck that discharges the proppant beneath the truck. The unloader 220 transfers the proppant via a conveyor to an intake of a stacker 230. The stacker 230 delivers the proppant via conveyor to above the pile 240, where the proppant is dropped onto the pile 240. To reduce the proppant dust floating in the air, which may pose a health hazard, steps may be taken to suppress the dust created. One way to reduce the proppant dust is by conducting the falling proppant through a load spout 232 that runs from the top of the stacker 230 to the proppant pile 240. The load spout 232 will be discussed further below. A self-feeding conveyor (for example, a primary feed conveyor) 280 is configured to be disposed with a proppant inlet underneath the proppant pile 240. Without operator intervention or control, the self-feeding conveyor 280 provides proppant to a transfer conveyor 284. The self-feeding conveyor 280 does not require an operator-controlled wheel loader 250 to transfer proppant from the proppant pile 240 to the transfer conveyor 284. Advantageously, the self-feeding conveyor 280 frees up a crew member and reduces or eliminates accidents, injuries, and fatalities related to constant activity of an operator-controlled wheel loader 250. Further, transferring proppant from the pile 240 to the transfer conveyor 284 using the self-feeding conveyor 280 can significantly reduce or eliminate the creation of dust that is inherent in a system that uses a loader like a wheel loader 250 to make the same transfer.

In one or more embodiments, two or more self-feeding conveyors 280 may be used to transfer proppant from the pile 240 to the transfer conveyor 284 to provide redundancy for a system that must be available for extended periods of time without stopping. Additionally, a backup feed conveyor 288 may be provided. The backup feed conveyor 288 may be positioned to receive proppant delivered by an operator-controlled wheel loader 250.

Still referring to FIG. 2, the transfer conveyor 284 provides a means of delivering proppant from the pile 240 to a metering conveyor 270 by means of a plurality of conveyors 280, 284. The transfer conveyor 284 transfers the proppant to a metering conveyor 270. The metering conveyor 270 measures and controls the rate at which proppant is delivered into the blender 210.

FIG. 3 is a schematic view of a self-feeding proppant delivery system 300 that supplies proppant to a blender 310. The self-feeding proppant delivery system 300 includes an unloader 320 that receives proppant from a transfer vehicle such as a dump truck. The unloader 320 carries proppant to the stacker 330, which drops the proppant on a pile 340. Self-feeding conveyor 380 carries proppant from the pile 340 to the transfer conveyor 384. In one or more embodiments, one or more additional self-feeding conveyors 382 may be included in the self-feeding proppant delivery system 300 for backup in the event of equipment failure. Similarly, an operator-controlled wheel loader 350 may transfer proppant from the pile 340 to a backup feed conveyor 388 that carries the proppant to the transfer conveyor 384. As discussed above, the proppant then passes from the transfer conveyor 384 to the metering conveyor 370 and into the blender 310. In one or more embodiments, the transfer conveyor 384 and the metering conveyor 370 may be a single conveyor.

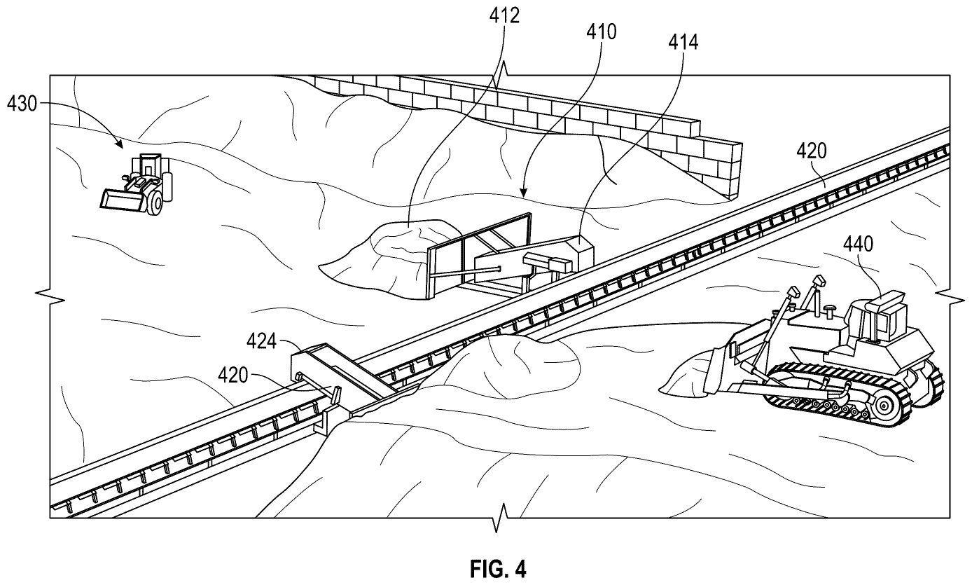

FIG. 4 provides a perspective view of two feed conveyors 410, 420 that may be configured to operate as self-feeding conveyors if placed with their inlets at a pile of proppant. In a first example, feed conveyor 410 may receive material at an inlet 412 and carry that material to an outlet 414 where it is deposited on a transfer conveyor 420. In this example, a wheel loader 430 provides material for the feed conveyor 410.

In a second example in FIG. 4, a dozer 440 pushes material from above into the inlet (obscured) of a second feed conveyor 420. An outlet 424 delivers the material to transfer conveyor 420.

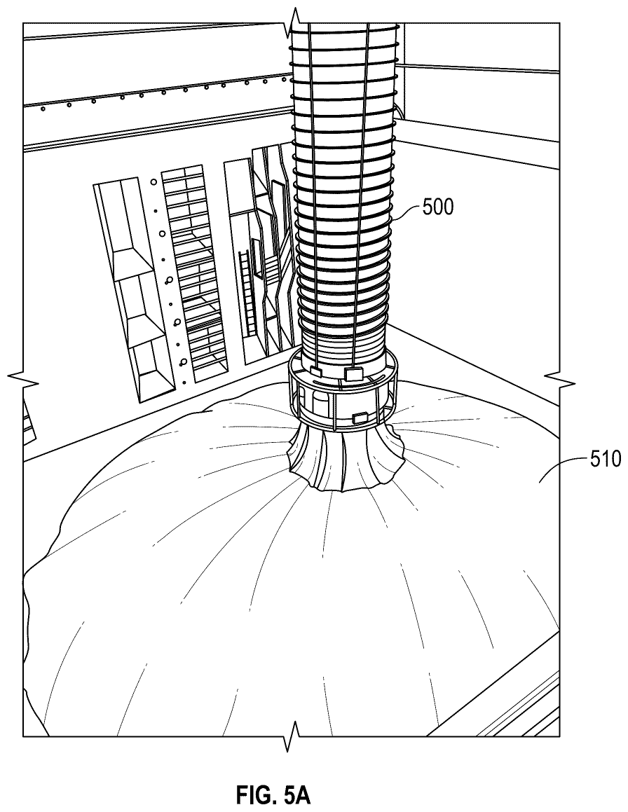

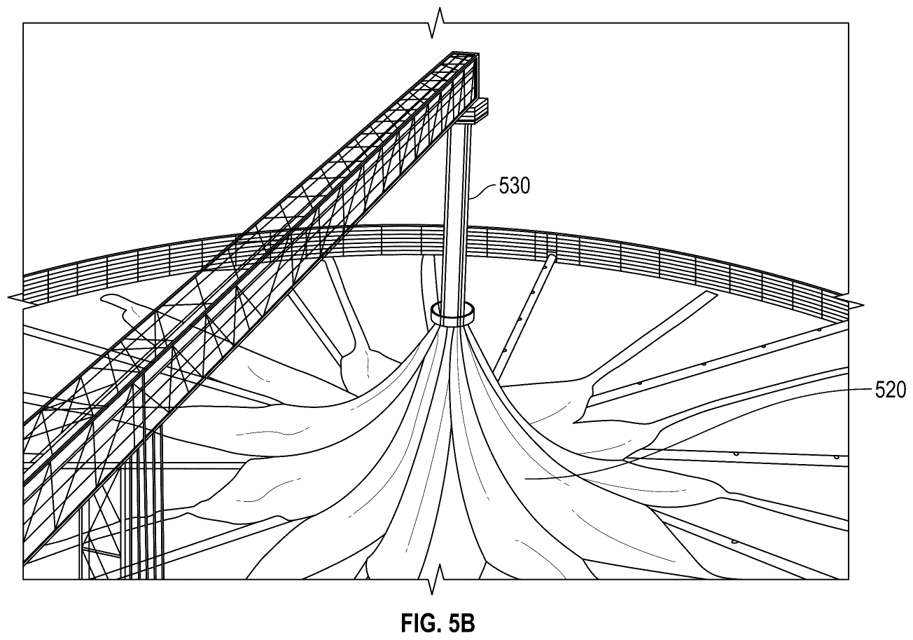

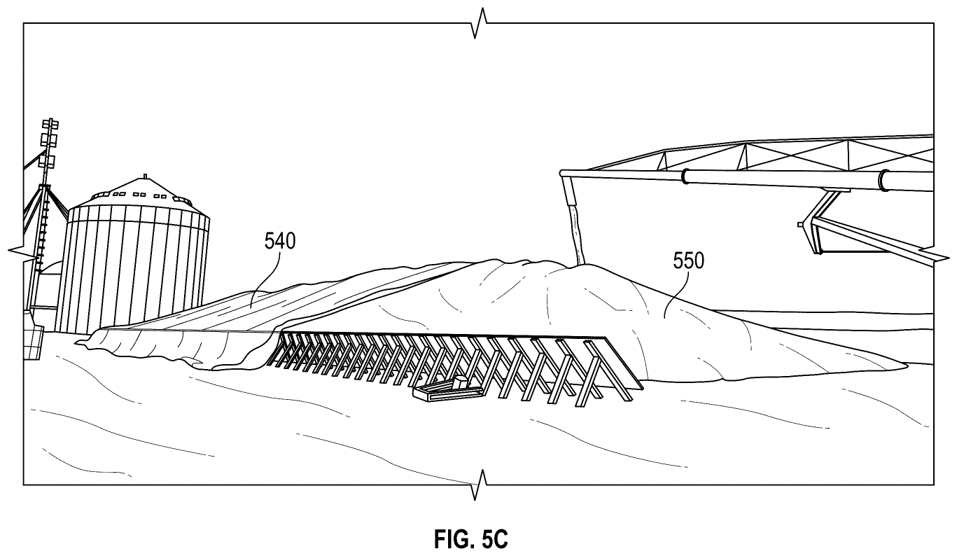

In FIG. 5A, a load spout 500 captures dust particles produced in the transfer and, particularly, the piling of proppant. The length of the load spout can be adjusted as the proppant pile grows so that the load spout 500 covers the distance between the top of the stacker and the top of the pile 510. The load spout 500 may include a material that is impervious to dust, proppant dust in particular.

Similarly, FIGS. 5B and 5C present two additional systems for reducing dust produced by piling granular material like proppant. In FIG. 5B, the proppant fills an expandable canopy 520 that opens to the volume of the contents. The canopy 520 may be attached to a fixed-length spout 530 extending from a stacker. In FIG. 5C, a cover 540 is extended across the top of a pile 550 of proppant. This cover 540 may be effective in reducing particulate dust from the pile 550 after it has been created but is not intended to reduce dust produced during the creation of the pile 550. The canopy 520 and the cover 540 may include a material that is impervious to dust.

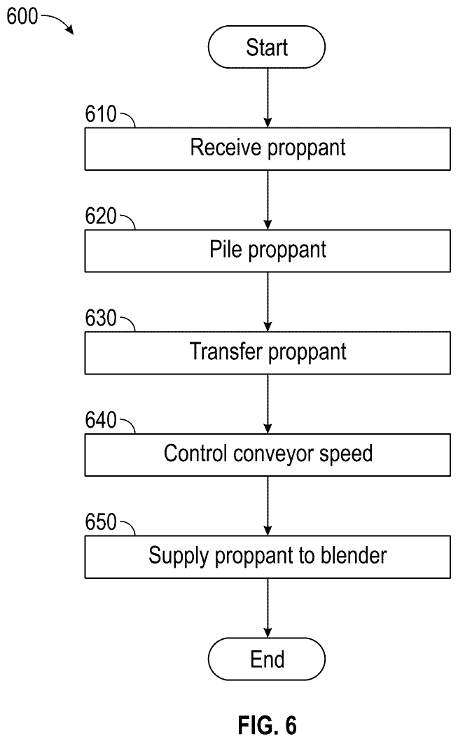

A method of self-feeding proppant delivery to a blender in accordance with one or more embodiments is presented in FIG. 6. Proppant is delivered to the worksite with a transport vehicle, such as a dump truck, although any appropriate transport vehicle including water-going vessels. At step 610, the proppant is received from the transport vehicle using an unloader. At step 620, a pile of the proppant is created using the unloader and/or a stacker. The pile is created over a proppant inlet of a self-feeding conveyor. The self-feeding conveyor operates without operator interaction. In contrast, a wheel loader or similar type vehicle is operated by a human operator who controls the wheel loader moment by moment in the process of moving proppant from the pile to a hopper or conveyor. The unloader may deliver the proppant to an intake of a stacker. The intake may be a hopper or other suitable structure. The unloader may include a conveyor belt and/or an auger. The stacker takes the proppant from the intake and delivers the proppant to the pile. In one or more embodiments, the unloader and the stacker may be combined into a single piece of equipment. In one or more embodiments, a load spout may be attached to the output end of the stacker to reduce the dust created while building or maintaining the pile of proppant. In one or more embodiments, the load spout has an adjustable length that allows the load spout to extend from the output of the stacker to the top of the pile. In one or more embodiments a covering may be placed over the proppant pile. The pile may be place over the pile after the pile is built. In other cases, the cover may be attached to the output of the stacker and fill as the proppant is piled. The proppant may be wet or dry.

At step 630, the proppant is transferred directly from the pile to a metering conveyor or using an intermediary conveyor, namely, a transfer conveyor. The transfer is accomplished using the self-feeding conveyor. In one or more embodiments, one or more additional self-feeding conveyors may be use. In addition, an operator-controlled loaded such as a wheel loader may be used as a backup to deliver proppant from the pile to the transfer conveyor or the metering conveyor. The transfer conveyor moves the proppant from the self-feeding conveyor to the metering conveyor. The transfer conveyor and the metering conveyor may be incorporated into a single piece of equipment. At step 640, the speed of the self-feeding conveyor and/or the speed of the delivery system may be controlled using the metering conveyor. The speed is adjusted so that the correct ratio of proppant to fluid is achieved in the blender. This ratio may change during an operation. In addition, even if the ratio is kept constant, the rate of injecting fluid may vary during an operation, affecting the rate at which proppant needs to be supplied. Thus, the proppant is supplied to the blender at a required rate using the metering conveyor at step 650. Further, the steps described above may be combined, changed, or done in a different order.

Examples of the above aspects include:

Example 1 is a method for transferring proppant, delivered to a worksite by a transport vehicle, to a blender, the method comprising creating a pile of the proppant, using an unloader and/or a stacker, at a proppant inlet of a self-feeding conveyor; transferring the proppant, using the self-feeding conveyor without operator interaction and a metering conveyor, from the pile to the blender; controlling a mass rate, using the metering conveyor, to vary at least one of a speed of the self-feeding conveyor, a speed of the metering conveyor, or a variable opening onto the self-feeding conveyor and/or the metering conveyor; and supplying the proppant, using the metering conveyor, to the blender at a selected rate.

Example 2 includes all the previous examples wherein creating the pile comprises receiving the proppant, using the unloader, from the transport vehicle.

Example 3 includes all the previous examples wherein the unloader comprises a conveyor belt and/or an auger.

Example 4 includes all the previous examples wherein creating the pile of the proppant further comprises: delivering the proppant, by the unloader, to an intake of the stacker; and delivering the proppant, by the stacker, to the pile.

Example 5 includes all the previous examples wherein the stacker comprises a conveyor belt and/or an auger.

Example 6 includes all the previous examples further comprising reducing dust generated by piling the proppant.

Example 7 includes all the previous examples wherein reducing dust comprises using: a load spout, adjustable in length, that extends from an output of the stacker to a top of the pile, and/or a covering extending over the pile, wherein the load spout and the covering are impervious to proppant dust.

Example 8 includes all the previous examples wherein transferring the proppant further comprises using at least one of the self-feeding conveyors, an additional self-feeding conveyor, or an operator-controlled loader to transfer the proppant to a transfer conveyor that supplies the proppant to the metering conveyor.

Example 9 includes all the previous examples wherein the proppant is wet.

Example 10 includes all the previous examples wherein the proppant is dry.

Example 11 includes all the previous examples wherein supplying the proppant to the blender further comprises feeding the proppant, using the metering conveyor, into the blender.

Example 12 includes all the previous examples wherein feeding the proppant into the blender further comprises moving the proppant, using a transfer conveyor, from the self-feeding conveyor to the metering conveyor.

Example 13 is a system for moving proppant, delivered to a worksite using a transfer vehicle, to a blender, the system comprising: a self-feeding conveyor comprising a proppant inlet configured to be disposed at a pile of the proppant, the self-feeding conveyor operable to transfer, without operator interaction, the proppant from the pile; and a metering conveyor operable to receive the proppant from the self-feeding conveyor, the metering conveyor being operable to control a mass rate by varying at least one of a speed of the self-feeding conveyor, a speed of the metering conveyor, or a variable opening onto the self-feeding conveyor or the metering conveyor to supply the proppant to the blender at a selected rate.

Example 14 includes all the previous examples, further comprising an unloader operable to receive the proppant from the transfer vehicle.

Example 15 includes all the previous examples wherein the system further comprises a stacker operable to receive the proppant from the unloader and transfer the received proppant to the pile.

Example 16 includes all the previous examples wherein the system further comprises a transfer conveyor operable to receive the proppant from at least the self-feeding conveyor and supply the proppant to the metering conveyor, wherein the metering conveyor is operable to control a speed of the transfer conveyor.

Example 17 includes all the previous examples further comprising a load spout, adjustable in length, configured to be suspended from an end of the stacker and extending to the top of the pile.

Example 18 includes all the previous examples, wherein the load spout is impervious to dust.

Example 19 includes all the previous examples wherein the transfer conveyor is configured to receive proppant from a plurality of self-feeding conveyors.

Example 20 includes all the previous examples further comprising an operator-controlled wheel loader operable to transfer proppant from the pile to the transfer conveyor.

Certain terms are used throughout the description and claims to refer to particular features or components. As one skilled in the art will appreciate, different persons may refer to the same feature or component by different names. This document does not intend to distinguish between components or features that differ in name but not function.

For the aspects and examples above, a non-transitory computer readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various aspects of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of information. Such a user interface can be operated in conjunction with the communications unit and the bus. Various components of the system can be integrated such that processing identical to or similar to the processing schemes discussed with respect to various aspects herein can be performed.

While descriptions herein may relate to “comprising” various components or steps, the descriptions can also “consist essentially of” or “consist of” the various components and steps.

Unless otherwise indicated, all numbers expressing quantities are to be understood as being modified in all instances by the term “about” or “approximately”. Accordingly, unless indicated to the contrary, the numerical parameters are approximations that may vary depending upon the desired properties of the present disclosure. As used herein, “about”, “approximately”, “substantially”, and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus 10% of the particular term and “substantially” and “significantly” will mean plus or minus 5% of the particular term.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims. Moreover, the rotating equipment (e.g., motors) and valves disclosed herein are envisaged as being operable at specified speeds or variable speeds through inverter circuitry, for example. Moreover, the internal and external communication of the self-feeding proppant delivery system may be accomplished through wired and or wireless communications, including known communication protocols, Wi-Fi, 802.11 (x), Bluetooth, to name just a few.

What is claimed is:

1. A method for transferring proppant, delivered to a worksite by a transport vehicle, to a blender, the method comprising:
creating a pile of the proppant, using an unloader and/or a stacker, at a proppant inlet of a self-feeding conveyor;
transferring the proppant, using the self-feeding conveyor without operator interaction and a metering conveyor, from the pile to the blender;
controlling a mass rate, using the metering conveyor, to vary at least one of a speed of the self-feeding conveyor, a speed of the metering conveyor, or a variable opening onto the self-feeding conveyor and/or the metering conveyor; and
supplying the proppant, using the metering conveyor, to the blender at a selected rate.

2. The method of claim 1, wherein creating the pile comprises receiving the proppant, using the unloader, from the transport vehicle.

3. The method of claim 2, wherein the unloader comprises a conveyor belt and/or an auger.

4. The method of claim 2, wherein creating the pile of the proppant further comprises:
delivering the proppant, by the unloader, to an intake of the stacker; and
delivering the proppant, by the stacker, to the pile.

5. The method of claim 4, wherein the stacker comprises a conveyor belt and/or an auger.

6. The method of claim 4, further comprising reducing dust generated by piling the proppant.

7. The method of claim 6, wherein reducing dust comprises using:
a load spout, adjustable in length, that extends from an output of the stacker to a top of the pile, and/or
a covering extending over the pile,
wherein the load spout and the covering are impervious to proppant dust.

8. The method of claim 1, wherein transferring the proppant further comprises using at least one of the self-feeding conveyors, an additional self-feeding conveyor, or an operator-controlled loader to transfer the proppant to a transfer conveyor that supplies the proppant to the metering conveyor.

9. The method of claim 1, wherein the proppant is wet.

10. The method of claim 1, wherein the proppant is dry.

11. The method of claim 1, wherein supplying the proppant to the blender further comprises feeding the proppant, using the metering conveyor, into the blender.

12. The method of claim 11, wherein feeding the proppant into the blender further comprises moving the proppant, using a transfer conveyor, from the self-feeding conveyor to the metering conveyor.

13. A system for moving proppant, delivered to a worksite using a transfer vehicle, to a blender, the system comprising:
a self-feeding conveyor comprising a proppant inlet configured to be disposed at a pile of the proppant, the self-feeding conveyor operable to transfer, without operator interaction, the proppant from the pile; and
a metering conveyor operable to receive the proppant from the self-feeding conveyor, the metering conveyor being operable to control a mass rate by varying at least one of a speed of the self-feeding conveyor, a speed of the metering conveyor, or a variable opening onto the self-feeding conveyor or the metering conveyor to supply the proppant to the blender at a selected rate.

14. The system of claim 13, further comprising an unloader operable to receive the proppant from the transfer vehicle.

15. The system of claim 14, wherein the system further comprises a stacker operable to receive the proppant from the unloader and transfer the received proppant to the pile.

16. The system of claim 13, wherein the system further comprises a transfer conveyor operable to receive the proppant from at least the self-feeding conveyor and supply the proppant to the metering conveyor, wherein the metering conveyor is operable to control a speed of the transfer conveyor.

17. The system of claim 15 further comprising a load spout, adjustable in length, configured to be suspended from an end of the stacker and extending to the top of the pile.

18. The system of claim 17, wherein the load spout is impervious to dust.

19. The system of claim 16 wherein the transfer conveyor is configured to receive proppant from a plurality of self-feeding conveyors.

20. The system of claim 16 further comprising an operator-controlled wheel loader operable to transfer proppant from the pile to the transfer conveyor.
